(19) United States
(12) Patent Application Publication
(10) Pub. No.: US 2013/0290056 A1
(43) Pub. Date: Oct. 31, 2013

(54) SCHEDULE OPTIMISATION

(71) Applicant: SKEDGO PTY LTD, The Rocks (AU)

(72) Inventor: Tim Cooper, Barden Ridge (AU)

(73) Assignee: SKEDGO PTY LTD, The Rocks, New South Wales (AU)

(21) Appl. No.: 13/872,272

(22) Filed: Apr. 29, 2013

(30) Foreign Application Priority Data
Apr. 27, 2012 (AU) AU 2012901668

(51) Int. Cl. G06Q 10/10

(52) U.S. Cl. CPC G06Q 10/1093
USPC 705/7.18

(57) ABSTRACT

This disclosure concerns the iterative optimisation of schedules, such as calendars. A computer system receives or determines first candidate schedule items. Each candidate schedule item has parameters, and each parameter is fixed or variable and each candidate schedule item comprises a value for each parameter. The system determines second candidate schedule items by permutating the variable parameters of each of the first candidate schedule items and determines a cost for each of the second candidate schedule items. The system then selects a subset of the second candidate schedule items based on the cost and feeds back the subset to be taken as the first candidate schedule items. Since each parameter has a value the cost for each permutation can be determined and the number of candidate schedule items for the next iteration can be reduced. This avoids the exponential complexity of calculating the cost for each possible combination.

### TECHNICAL FIELD

This disclosure concerns the optimisation of schedules. In particular, the invention concerns, but is not limited to, methods software and computer systems for optimising schedule items of a calendar.

### BACKGROUND ART

Many calendar applications are available for a user to plan events. Such applications include Microsoft Outlook, Apple iCal and Mozilla Sunbird. These calendar applications provide users with the option of defining start dates and durations of events and of visualising multiple events in a calendar view. The calendar applications also support data sharing such that other users can identify free and busy time times of a user to plan events accordingly.

### DISCLOSURE OF INVENTION

In a first aspect there is provided a computer system for iteratively optimising a schedule item of a calendar the system comprising:
an input port to receive or a processor to determine one or more first candidate schedule items, each candidate schedule item having multiple parameters, and each parameter being fixed or variable, wherein each candidate schedule item comprises a value for each parameter;
a permutation module to determine one or more second candidate schedule items by permutating the variable parameters of each of the one or more first candidate schedule items;
a costing module to determine a cost for each of the one or more second candidate schedule items based on the values of the parameters;
a selection module to select a subset of the one or more second candidate schedule items based on the cost;
a feedback module to make available to the permutation module the subset of the one or more second candidate schedule items to be taken as the one or more first candidate schedule items; and
a data store to store the subset of the one or more second candidate schedule items.

It is an advantage that each candidate schedule item comprises a value for each parameter. Therefore, the cost of this candidate schedule item and the cost for each permutation can be determined based on the values and the number of candidate schedule items for the next iteration can be reduced. As a result, the exponential complexity of calculating the cost for each possible combination of parameter values is avoided.

The schedule item and the candidate schedule items may be associated with two or more participants.

A second candidate schedule item determined by the permutation module from a first candidate schedule item may differ from that first candidate schedule item in the value for one and only one variable parameter.

It is an advantage that there are only small differences between the first and second candidate schedule items. As a result, the cost can be computed more efficiently.

Determining the cost may be based on a determined cost of similar candidate schedule items.

It is an advantage that since similar candidate schedule items have similar cost the determination of the cost based on previously determined cost is faster.

The permutation module may permutate one and only one variable parameter of each of the one or more first candidate schedule items, and the permutation module may create one candidate schedule item for each possible value for the one and only one variable parameter.

It is an advantage that all possible values of the variable parameter are considered. As a result, a beam search that is exhaustive in each parameter individually can be performed without creating an unfeasibly large number of candidate schedule items.

The computer system may further comprise the feedback module to determine whether all variable parameters have been permutated and if so not send the subset of the one or more second candidate schedule items to the permutation module.

The one or more first candidate schedule items and the subset of the one or more second candidate schedule items each may consist of one and only one candidate schedule item; and permutating the variable parameters may comprise creating exactly one candidate schedule item for each variable parameter, such that the created candidate schedule item and the first candidate schedule item differ in only that parameter.

It is an advantage that the computer system determines the cost for each variable parameter. As a result, a path of steepest decent is found through the parameter space that finds the optimal schedule item with a small number candidate schedule items being assessed.

The system further may comprise the permutation module to determine whether the cost of the selected candidate schedule item is lower than the cost of the candidate schedule item selected in the previous iteration and if not, to randomly change the value of one or more variable parameters of the selected candidate schedule item.

It is an advantage that a random perturbation is included into the computer system. As a result, the optimisation does not terminate in a local optimum but is more likely to proceed to a global optimum.

The computer system may further comprise the feedback module to determine whether a predetermined maximum number of random parameter changes is reached and if so not send the subset of the one or more second candidate schedule items to the permutation module.

The calendar may comprise a fixed schedule item and the cost for each of the one or more second candidate schedule items may be based on the fixed schedule item.

The parameters may be one or more of:
starting time of the event;
location of the event;
mode of transport for each participant; and
return option for each participant.

The starting time of the event may be discrete, such that starting times with a predetermined time difference between each starting time are the possible values for the starting time of the event.

The costing module may determine a travel time for each participant and each candidate schedule item and the cost may be based on the travel time.

It is an advantage that the travel time is considered. As a result, optimal schedule items are those with the shortest travel times and less time is wasted for travelling unnecessarily.

The travel time may based on a routing for each participant.

It is an advantage that routing determines an accurate estimate for the actual travel time. As a result, the computer system is more reliable in reducing travel time of the participants.

The routing may be based on one or more of:
map based routing,
flight timetables, and
public transport timetables.

It is an advantage that multiple different modes of transport are considered. As a result, the computer system can be used for schedule items with locations limited to a small area, such as one city, or for schedule items with worldwide locations.

The cost may be based on any one or more of:
an expense associated with a value of a parameter;
convenience of the candidate schedule item;
carbon footprint associated with the candidate schedule item;
environmental factors of the candidate schedule item;
health benefits of the candidate schedule item;
social factors associated with the candidate schedule item;
robustness of the candidate schedule item; and
reliability associated with the candidate schedule item.

The schedule item may be associated with an event or with a task.

The values for the multiple parameters of the one or more first candidate schedule items may be predetermined default parameters.

The system may comprise a cache:
to receive a cost request from the costing module,
to query a data store for a similar request,
if a similar request is found to retrieve the cost associated with the request from the data store,
otherwise to determine the cost and store the cost associated with the received request on the datastore, and
to return the determined or retrieved cost to the costing module.

It is an advantage that the use of a cache greatly reduces the number of candidate schedule items for which a cost needs to be determined. Since the time for determining that cost is greater than the time for retrieving the cost from the data store, it is a further advantage that the computation time of the optimisation is reduced.

In a second aspect there is provided a computer implemented method for iteratively optimising a schedule item of a calendar, the method comprising the steps of:
receiving one or more first candidate schedule items, each candidate schedule item having multiple parameters, and each parameter being fixed or variable, wherein each candidate schedule item comprises a value for each parameter;
determining one or more second candidate schedule items by permutating the variable parameters of each of the one or more first candidate schedule items;
determining a cost for each of the one or more second candidate schedule items based on the values of the parameters;
selecting a subset of the one or more second candidate schedule items based on the cost;
determining whether a termination condition is met;
if the termination condition is not met repeating the method from the step of determining one or more second candidate schedule items where the subset of the one or more second candidate schedule items is taken as the one or more first candidate schedule items; and
if the termination condition is met storing on a data store the subset of the one or more second candidate schedule items.

In a third aspect there is provided software, that when installed on a computer causes the computer to perform the method for iteratively optimising a schedule item of a calendar.

Optional features described of any aspect, where appropriate, similarly apply to the other aspects also described here.

### BRIEF DESCRIPTION OF DRAWINGS

An example will be described with reference to

FIG. 1 illustrates a scenario for organising an event.

FIG. 2 illustrates a schedule item for an event.

FIG. 3 illustrates a computer system for iteratively optimising a schedule item of a calendar.

FIG. 4 illustrates a computer implemented method 400 for iteratively optimising a schedule item of a calendar.

### BEST MODE FOR CARRYING OUT THE INVENTION

FIG. 1 illustrates an example scenario 100 for organising an event, such as a meeting, with first participant 110, second participant 120 and third participant 130. Each of the participants 110, 120 and 130 is located at locations 114, 124 and 134, respectively.

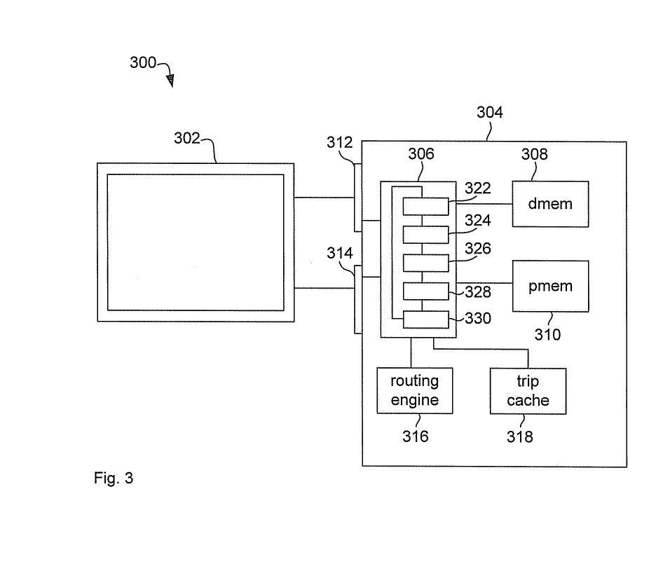

Each of the participants 110, 120 and 130 is connected by a computing device 302 in FIG. 3, such a smart phone, to a scheduling server 150 via a computer network, such as the Internet. Each of the participants 110, 120 and 130 has preferences stored on the scheduling server 150, such as preferred mode of transport or preference for schedules with lowest carbon emission. Further, each of the participants 110, 120 and 130 has a schedule, such as a calendar, 112, 122 and 132, respectively, that is hosted by the scheduling server 150 and displayed to the participants 110, 120 and 130 on their computer screen or a touch screen of a computing device, such as a mobile device.

The participants 110, 120 and 130 wish to organise the event at one of the locations 114, 124 and 134 during a given time range, for example on Tuesday or Wednesday during business hours. In the following description, the term time also includes the date. The scheduling server 150 schedules the event by determining associated with the event a schedule item of calendars 112, 122 and 132. The schedule item includes multiple parameters including time information, such as a starting time, ending time or duration, location information and transportation information. In this specification, unless noted otherwise, there is a distinction between an event and a schedule item. An event is something that happens in the real world, such as a meeting, while a schedule item is a data object stored in computer memory, such as an entry in an electronic calendar. The schedule item needs to be determined in an optimal way such that, for example, the travel time for each of the participants 110, 120 and 130 is minimised. Other cost factors may also be considered as described below. Further, the first participant 110 and the second participant 120 already have schedule items of other events, indicated by solid boxes, in their respective schedules 112 and 122 on Tuesday and Wednesday and are therefore constrained in the time for a new event.

In another example, the schedule items in schedules 112, 122 and 132 are wild card schedule items, which means that the location or time or both are missing from the schedule item of the respective event. The missing values are determined by the system and method described below once a participant sends a request accordingly. Further, any of the events in schedule 112, 122 and 132 may require other participants. That way, the schedule items in schedule 122 and schedule 112 may actually relate to the same event, but the time is not determined yet and therefore, the schedule item is displayed at different times in the schedules 112 and 122.

The participants 110, 120 and 130 have modes of transport 160, such as walking, bicycle, car or public transport, available to travel to their meetings. The optimised schedule item also includes information about the mode of transport.

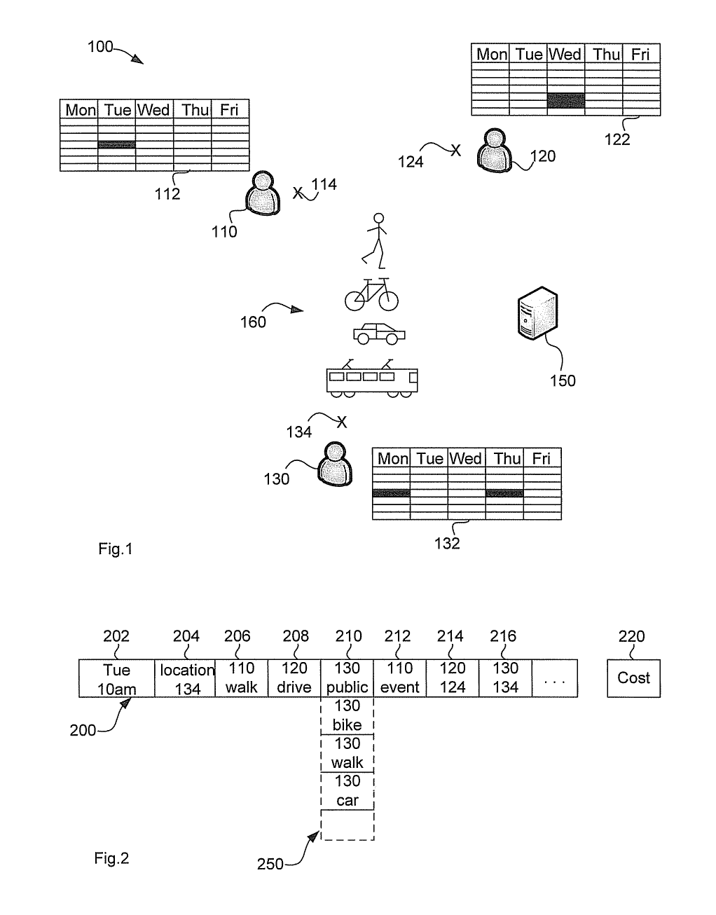

FIG. 2 illustrates a schedule item 200 for an event. Since the event involves participants 110, 120, 130, the schedule item 200 is associated with participants 110, 120, 130, that is some parameters of the schedule item are related to the individual participants. In this example, the schedule item 200 comprises parameters 202 to 216, such as a starting time 202 for the event, a location 204 where the event takes place, a mode of transport 206, 208, 210 used by participants 110, 120, 130 respectively, and a return option 212 to 216. The return option indicates an activity of a participant after the event has finished. In this example, participant 110 needs to travel to the already existing event, that is the fixed schedule item marked in schedule 112, after the new event (return option 212), and participants 214 and 216 are travelling back to their locations 124 and 134 respectively (return options 214 and 216). In a different example, the schedule item 200 is associated with only one participant.

A cost 220 is determined for schedule item 200. In this example, the cost is based on travel time of the participants. In other examples, the cost 220 is a weighted sum of many different contributions, such as carbon emissions, inconvenience or risk of running late. In yet another example, the cost is based on different weights for different locations, such that preferred locations result in a lower cost than other locations. The weights may also be different for each participant 110, 120 and 130 to account for situations where one participant is more important to arrive in time or has a higher hourly billing rate than the others.

The figure also illustrates a permutation 250 of one parameter 210 of the schedule item 200, that is parameter 210 is a variable parameter and the other parameters 202, 204, 206, 208, 212, 214 and 216 are fixed parameters. The variable parameter 210, which represents the mode of transport of participant 130, is changed such that all possible values, that is all possible modes of transport, are inserted in place of the current parameter value. For each of these possible values of mode of transportation, a new candidate schedule item is determined. As a result, the values for the fixed parameters 202, 204, 206, 208, 212, 214 and 216 remain the same and only the value of the variable parameter 210 changes.

The task is to find optimal or near-optimal schedule items from the determined candidate schedule items. It is noted that the number of candidate schedule items when permutating all parameters is exponential in the number of parameters and therefore too time consuming to compute for most practical numbers of parameters.

In one example, the parameters for time 202 and location 204 are permutated at the beginning of the optimisation process and the initial set of candidate schedule items contains one candidate schedule item for each combination of the times and the locations. In the example described with reference to FIG. 1 the values for the time parameter are all half an hour time intervals during business hours on Tuesday and Wednesday, that is 32 time slots, and the location values are locations 114, 124 and 134. As a result, 96 pairs are considered. From each pair a candidate schedule item is created by setting all other parameters to a default value, such as driving for mode of transport and return to initial location for return options.

FIG. 3 illustrates a computer system 300 for iteratively optimising a schedule item of a calendar. The computer system 300 comprises a touch screen device 302, such as a smart phone, and a computer 304 including a processor 306, data memory 308 and program memory 310. The computer 304 implements the scheduling server 150 in FIG. 1, receives data from the touch screen 302 device via input port 312 and sends data to the touch screen via output port 314.

The touch screen device 302 and the computer 304 communicate via a data network, such as the Internet, over WLAN or GSM/UMTS. In one example, the touch screen device 302 comprises a location detection device, such as a GPS receiver, for geolocating a participant of the touch screen device 302. The touch screen device 302 communicates location data of the participant, such as GPS coordinates, to the computer 304. The computer 304 uses the location data for optimising the schedule item, such as by using the current position of participant 110 as a starting point for travelling to the next event instead of location 114.

The touch screen device 302 displays a display generated by the computer 304 and provides a participant with the option of either viewing a calendar view similar to the calendars 112 FIG. 1 or alternatively, or at the same time, a map view showing travel routes to one or more events scheduled by the computer 304.

In one example, the touch screen device 302 displays a calendar view generated by the computer 304. In another example, the touch screen device 302 exports schedule items and other schedule data to the computer 304, receives from the computer 304 optimised schedule items and generates a display to be presented to the participant. In yet another example, the participant accesses a third party website, such as Google Calendar, for organising and viewing event data. The third party website is synchronised with the computer 304 such that the computer 304 receives optimisation requests or candidate schedule items from the third party website. In this example, the computer 304 returns the optimised schedule items to the third party website, which in turn, generates the display to be presented to the participant on the touch screen device 302.

In a different example, the touch screen device 302 is replaced by a PC or laptop with a separate display, keyboard and mouse/touchpad.

The computer comprises a routing engine 316, such as a intermodal journey planner, and a trip cache 318. In this example, the routing engine 316 is located within the computer but in other examples, the routing engine 316 is an external service and the computer sends routing requests to the routing engine via the Internet. There may even be multiple routing engines, such as a mapping service for driving and an air travel service for flight connections according to fixed time tables. The processor 306 queries these different routing engines based on the mode of transport of the current schedule item.

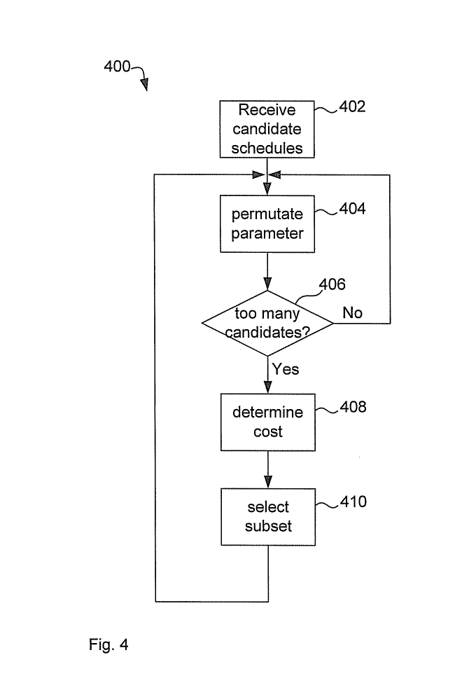

The computer 304 receives requests for scheduling events from the participants via input port 312, and the requests are stored in local data memory 308 by processor 306. In one example, the requests include one or more candidate schedule items, such as a tentative schedule item created by a participant. In different example, the computer 304 determines one or more candidate schedule items based on the information given with the request as described later. The processor 306 uses software stored in program memory 310 to perform the method shown in FIG. 4. In this sense the processor 306 performs the method for iteratively optimising a schedule item of a calendar. As a result, the processor operates as separate modules including an input port 322, a permutation module 324, a costing module 326, a selection module 328 and a feedback module 330.

A brief overview of the modules 322 to 330 of processor 306 is given here before the method performed by these modules is described later with reference to FIG. 4. The input port 322 of computer 306 receives or creates one or more candidate schedule items and provides these to the permutation module 324 that iteratively permutates one variable of the one or more candidate schedule items and thereby determines further candidate schedule items. The costing module 326 of computer 306 determines a cost for each permutation based on routing information from the routing engine 316. Since there may be a large number of permutations with potentially only small differences, the processor 306 stores the individual routes on the trip cache 318. For some permutations it is not necessary to query the routing engine 316 for a complete route but it is sufficient to find a similar route in the trip cache 318 and adjust the cost slightly to reflect the small change between the parameters of the current schedule item and the schedule item for which the route in the trip cache 318 was previously determined.

In another example, the routing engine 316 is connected to the trip cache 318 and not to the processor 306 directly. As a result, the processor 306 always queries the trip cache and the trip cache determines whether it is necessary to query the routing engine 316, that is the trip cache determines whether there has been a similar request for which a cost has already been determined and stored on a data store. Two candidate schedule items being similar means that the values for parameters of the two candidate schedule items differ only to a small degree, such as in one parameter, and the cost of the requested candidate schedule item is equal to the stored cost or can be determined with minor estimations from the stored cost. Since the routing engine 316 requires more computation time than the trip cache 318, the use of the trip cache 318 reduces the overall computation time.

In one example, there is a 2nd level of the trip cache 318 whereby similar but unequal queries can get results returned quickly, without requiring the routing engine. Driving queries can have their duration adjusted accurately and a new trip returned without any routing. Queries involving public transport or the possibility of public transport can get approximation trips returned without routing, based on (query, trip) pairs that already exist in the 2nd level cache, however only if the query specifies that guesses/approximations are allowed.

The selection module 328 of computer 306 then selects a subset of candidate schedule items based on a cost and the feedback module 330 sends the subset of candidate schedule items to the permutation module 324. This completes one iteration of the iterative optimisation. At each step of the iteration the computer 306 stores the candidate schedule items on the data memory 308 as a user schedule item object. This object represents the schedule item for a particular participant over a particular date-range, typically a small date-range in fact often a single date. It represents the activities the participant is planning to attend/perform and the trips between them. It is represented as a doubly-linked list with alternating objects of class ‘Trip’ and ‘Activity’, for ease of making incremental modifications. Each time an appointment changes place or time, these user schedule item objects are updated accordingly: trips are recalculated from the trip cache 318 and activities moved around. There are similarly vehicle schedule item objects to represent each private vehicle (cars, bicycles, motorcycles, car-share vehicles, but not taxis or buses/etc).

At the end of the last iteration, the optimal candidate schedule item is sent to the display device 302 and stored on data store 308. The computer 306 may also send multiple optimised schedule items, such that the participants can select the most suitable schedule item.

FIG. 4 illustrates a computer implemented method 400 for iteratively optimising a schedule item of an event having two or more participants. The method 400 commences by receiving 402 one or more candidate schedule items. In the first iteration the method 400 receives only a single candidate schedule item. It is important to note that each of the parameters of the candidate schedule item has a value associated with it. This makes it possible to determine a cost for this candidate and all candidates created by permutation of one parameter.

The received candidate schedule items have one or more variable parameters and multiple fixed parameters and the method proceeds by permutating 404 the one or more variable parameters. The decision which of the parameters is used as the one or more variable parameters and which remain fixed may be based on a variety of factors. In one example, all combinations of time slots and possible locations are generated during initialisation, that is a set of time/location pairs, and the time and location then remain fixed for the rest of the optimisation.

If there are too many time/location pairs a preliminary cost estimate, such as a travel time based on of direct distance, is used to select a predetermined number, such as 100, of best pairs. In another example, when generating the time location pairs, an additional penalty is included in the cost for one or more participants arriving late to the event when a particular time and location are chosen. In yet another example, the selection of the variable parameter is a random selection from all the parameters or all parameters except time and location.

The method 400 then continues with determining one or more new candidate schedule items by permutating 404 the variable parameter. In one example, the permutation 400 is performed according to a beam search principle. In a different example the permutation 400 is performed according to a simulated annealing principle.

According to the beam search principle, the method 400 may receive multiple candidate schedule items, such as from the initialisation with all time/location pairs, and only one parameter is variable. The method 400 starts with one of the received candidate schedule items and determines a new candidate schedule item for each possible value of the variable parameter. The method 400 repeats this process for the remaining received candidate schedule items and the same variable parameter. The method keeps track which parameters have been changed so far in order to terminate when all variable parameters have been permutated.

When the simulated annealing principle is used, the method 400 receives only a single candidate schedule item but more than one parameters are variable. The method 400 determines all new candidate schedule items that are possible by changing only one of the variable parameters.

Then, the method checks 406 whether the number of candidate schedule items is above a predetermined threshold. In case of the beam search option, an exemplary threshold is 50. If the threshold is not exceeded, the method returns to step 404 and determines more candidate schedule items until the threshold is exceeded. In case of the simulated annealing method only a single candidate schedule item is needed for the next iteration.

If the threshold is exceeded, the method determines the cost of each candidate schedule item. In one example, the cost of the candidate schedule item is the travel time of all participants but more cost factors may be considered as described further below. The cost of the candidate schedule items is based on the values of all parameters of the candidate schedule items and therefore this costing step 408 is only possible since all the parameters have values. Otherwise, all combinations of all parameters would have to be determined and a cost for all these combination would have to be computed. Since the complexity is exponential the number of combinations would be prohibitive for most practical applications.

In one example, the cost is also based on a fixed schedule item of at least one of the participants. In the example of FIG. 1, first participant 110 is associated with a fixed schedule item (filled rectangle) in the calendar 112, that is the schedule item in calendar 112 is not optimised at this stage. As a result, if the cost for a candidate schedule item is determined and the candidate schedule item is closely before the fixed schedule item in calendar 112 the cost incorporates the travel time from the location of the candidate schedule item to the location of the fixed schedule item of calendar 112. In a similar manner, if the time of the candidate schedule item is closely after the fixed schedule item in calendar 112, the cost incorporates the travel time from the location of the fixed schedule item to the location of the candidate schedule item. The proposed method takes into account the fixed schedule items in the calendars of all participants.

For example, the three participants 110, 120 and 130 are usually located at a large distance, such as more than 100 km, from each other and all participants 110, 120 and 130 attend the same conference. In this example, the conference relates to a fixed schedule item in each of the calendars 112, 122 and 132. The step of method 400 of determining 408 a cost for each candidate schedule item would result in a high cost for every candidate schedule item except those candidate schedule items that have the conference location as the value of the location parameter.

Based on the cost, the method 400 selects 410 a subset of candidate schedule items. In one example of the beam search, the method 400 selects the 50 candidate schedule items that have the lowest cost. When using the simulated annealing the method 400 selects only one candidate schedule item, that is the candidate schedule items with the lowest cost. In case of simulated annealing the method 400 further determines whether the candidate schedule item is different from the candidate schedule item of the previous iteration, that is whether the cost has been reduced by the change of a single parameter. If this is not the case, the method 400 selects one random parameter from the candidate schedule item and changes the value of that parameter.

The method 400 is then repeated from step 404 such that the candidate schedule items of the subset of candidate schedule items that has been selected in step 410, or the schedule item with the changed random parameter in the example of simulated annealing, are now the received candidate schedule items.

In case of the beam search, the method 400 iterates until all parameters have been permutated. In case of the simulated annealing, the method 400 iterates until a predetermined maximum number of random parameter permutations, such as 100, is reached.

In one example, after the last iteration of beam search, the method 400 selects a small number of optimised candidate schedule items, such as three, with the lowest cost, to send these candidate schedule items to the participants. Then the participants can choose which candidate schedule item suits them best. In one example, the candidate schedule items are displayed to the participants in their calendar application, such as Microsoft Outlook, Google Calendar, Mozilla Sunbird or Apple iCal. The participants can then select one of the proposed candidate schedule items.

In the above example, method 400 is used to determine the schedule item of a single event but in other examples, the method 400 is used to determine a schedule item of multiple events. The only difference is that the parameters of the schedule item include the parameters of all events that need to be scheduled. That is for three events, for example, the schedule item in FIG. 2 comprises three times the parameters. The number of parameters may also be more or less in case the multiple events have a different number of participants or a different number of transport options due to preferences set by some of the participants.

An example of an application of the method 400 using the beam search will now be provided with reference to FIG. 1. The first participant 110, the third participant 130 and the second participant 120 want to meet for 1 hour to discuss “Meteorology”. They will meet either in the office of the first participant 110 at location 114, the office of the third participant 130 at location 134 or the office of second participant 120 in location 124. They want the meeting to be within business hours on Tuesday or Wednesday.

While the participants 110, 120 and 130 are located at locations 114, 124 and 134 respectively, during business hours, they live at different locations (not shown) where they start at the beginning of the working day and where they return to at the end of the working day.

The first participant 110 has another meeting, at a meeting location 12:30-14:00 on Tuesday. The second participant 120 has a seminar Wednesday 14:00-17:00 at location 124. No-one else has any other meetings for those 2 days.

The steps in this example are

1. Initialise a Beam Search using a Beam of just 1 candidate schedule item. This candidate schedule item contains all the fixed appointments: Meeting, seminar, and each of the 3 participants being at home Tuesday morning, Tuesday evening/Wednesday morning and Wednesday evening. The transport method for each participant is the default one, namely that they each drive to each appointment in their own vehicle.

2. For the next generation of the beam search, (the next ‘beam’), the method 400 considers alternative (time, date) pairs for the Meteorology meeting. So, the method 400 generates a set of possible meeting times: {Mon 9:00, Mon 9:30, Mon 10:00, . . . Mon 16:30, Tue 9:00, . . . Tue 16:30}

3. The method generates a set of possible (time, place) pairs:

{
(location 124, Tue 9:00),
(location 124, Tue 9:30),
. . .
(location 124, Wed 16:30),
(location 114, Tue 9:00),
(location 114, Tue 9:30),
. . .
(location 114, Wed 16:30),
(location 134, Tue 9:00),
. . .
}

4. This results in 96 pairs, which is less than 100, so there is no need to do the “rough scoring”.

5. For each pair, the method creates a new candidate schedule item with this (time, place) and copies the other parameter from the initial candidate schedule item. This gives us 96 candidate schedule item objects. This is less than the predetermined threshold, such as 100, so no scoring is performed. If the number of candidate schedule items is larger than the threshold, the number of candidate schedule items is reduced based on the distance from the participants' home location and the place in the candidate schedule item.

6. For generation 3, the method considers alternative ways for the first participant 110 to arrive at the Meteorology meeting. These include:
a. Taking public transport (including taxis)
b. Driving his Corolla
c. Riding his mountain bike
d. Being brought by the second participant 120
e. Being brought by the third participant 130
   So, for each candidate schedule item in Beam 2, the method 400 determines 5 new candidate schedule items. This results in 480 candidate schedule items.

7. The method needs to reduce the 480 candidate schedule items down to 50. The method determines the cost for each candidate schedule item and selects the 50 best candidate schedule items, and this constitutes Beam 3.

8. Repeat steps 6 and 7 for the second participant 120.

9. Repeat steps 6 and 7 for the third participant 130.

10. Repeat steps 6 and 7 for the first participant 110 returning to work (or home) after the Meteorology appointment.

11. Repeat steps 6 and 7 for the first participant 110 attending the meeting.

12. Repeat steps 6 and 7 for the first participant 110 returning to work (or home) after the meeting.

13. Repeat steps 6 and 7 for the second participant 120 attending the seminar.

14. Do likewise for the second participant 120 and his appointments.

15. Do likewise for the third participant 130 and his appointments.

16. Take the best 3 candidate schedule items from the final Beam (Beam 5) according to the schedule item scoring formula.

17. Display these to the participant.

### Example of Scoring a Schedule Item

Suppose the first participant 110 is taking public transport to and from all his appointments. Suppose the third participant 130 is taking his motorbike to and from all his appointments. Suppose the second participant 120 is taking public transport to and from all his appointments, except the Meteorology appointment when the third participant 130 will pick him up and bring him on the back of the motorbike.

Suppose the Meteorology appointment is at 11:00 Wednesday at location 114.

Score 80 for the first participant 110 for the Tuesday morning trip home to work.

Score 80 for the first participant 110 returning home on Tuesday.

Score 80 for the first participant 110 going to work on Wednesday

Score 80 for the first participant 110 returning home on Wednesday.

Score 30 for the second participant 120 going to work on Tuesday

Score 30 for the second participant 120 returning home on Tuesday

Score 30 for the second participant 120 going to work on Wednesday

Score 30 for the second participant 120 returning home on Wednesday

Score 110 for the third participant 130 going to work on Tuesday

Score 110 for the third participant 130 returning home on Tuesday

Score 110 for the third participant 130 going to work on Wednesday

Score 110 for the third participant 130 returning home on Wednesday

Score 110 for the third participant 130 returning home on Wednesday

Score 9 for the third participant 130 driving the motorbike to the office of the second participant 120 at location 124.

Score 12 for the third participant 130 driving the motorbike with the second participant 120 on it, to the Meteorology meeting at location 114.

Score 19 for the third participant 130 driving the motorbike to location 134 after the meeting

Score 44 for the second participant 120 to return to his office by public transport at 12:30 Wednesday.

The trip scores are calculated by the routing engine 316 in FIG. 3. The method 400 determines the cost of the candidate schedule item as the sum of these numbers. In this scenario, no-one misses any time from the meeting, so there is no “depart early” or “arrive late” penalty. In this example, the smaller the cost, the better the candidate schedule item is considered to be.

The following description provides alternatives that may apply to the optimisation method 400.

In one example, the route of a participant comprises multiple sections, such as car pooling with a neighbour to a bus stop, taking the bus to a train station, taking the train and walk the last section. In this case, the car pooling is only available during certain times. This is integrated into method 400 by determining a mode of transport based on the time of the candidate schedule item. This determination is made by the permutation module, since at the step of permutation, the time of each candidate schedule item is known. If the mode of transport is fixed with the value car pooling and the time is the variable parameter, candidate schedule items are created only for time values for which car pooling is possible. If car pooling is chosen as a mode of transport for one section, the remaining sections are determined by the routing engine 316 that includes a travel planner of a public transport provider in this example.

In another example the task is to determine a time and place for 3 mining executives who are based in Rome, Tokyo and Mumbai, respectively, to meet by 1 December. Knowing all three participant's schedules and available seats on all flights departing near them (the participant based in Rome is visiting Berlin for the week) are starting points. To return an optimal schedule, such as 1 pm, 27th November, Sovietsky Historical Hotel, Moscow, 100s if not 10,000s of variables of flights, ground transports, their relative cost & time need to be considered and matched against free time in three calendars.

In another example, Mumbai is replaced with Mount Is a in the inland of Australia, and the best international airport, such as Darwin, Brisbane, Sydney or Perth and that executive's route to that international airport needs to be determined. In this case, the much longer trip may result in a different meeting location, such as Singapore.

In one example, rather than just letting the participants specify their preferences, the system learns what is important to them by observing which options they pick or rank highly. That way the system can also infer much more complex preferences, which would be too cumbersome for the participant to enumerate, such as different modes being preferred depending on the weather, or different value of time dependent on the mode of transport. The system learns from the actual travel patterns of the participants. The multi-modal routing results get automatically improved from information that participants which allow the system to track their general movement patterns. This most importantly includes where to change when switching modes as well as which roads to take when driving.

In some examples, for determining the cost the method 400 takes into account various additional real-life and real-time factors, such as typical and current traffic conditions, scheduled road works and public transport changes, preferences across all travellers, available vehicles, parking information (on-street and car park information including pricing), and forecasted as well as current weather.

In other examples, for determining the cost the method 400 considers the robustness of a trip, which considers the participant's risk attitude. The robustness of a trip depends on how much time is available between changes to scheduled services, and how much longer the trip would take if a connection is missed due to unforeseeable events. If a participant indicates that it is highly important to arrive at a particular event in time, the optimisation will prefer candidate schedule items with more time for changing between modes of transport or routes that have more frequent services to lessen the impact of missing one.

When looking at a particular routing result for how to get from some location to another at a particular time of day, the participant also has the option to view alternatives of this particular trips for situations where are real-time changes. This includes situation such as: “What if I missed this connection? How should I proceed and how much later will I be?”, “This road is congested. Which other way can I take from here?”

In another example, the system 300 may provide taxi sharing, such that the taxi sharing arrangement is determined by the optimisation, that is before the participants need to use the taxi. This pre-scheduling is possible, since the parameters of the candidate schedule items of the participants are known. As a result, the shared taxi is one part of a multi-mode trip that may also include flights and other ground transport, that is the shared taxi is one of modes of transport 160 in FIG. 1.

For example, two businessmen can share a taxi at the airport if they both go to the city. Upon the request of the first businessman for how to get to the city once he arrives, he can pick the taxi option and advertise it to other participants that he's interested in sharing the taxi. Participants who subsequently search for similar trips allowing taxi within a similar departure date, can then see those options for sharing taxis with others. This applies similarly to car pooling and to including information about reputation and trust-levels between participants.

The method 400 may further compare scores of candidate schedule item attributes visually. In one example, the available modes of transport are different depending for each participant. As a result, different resources of participants, such as the availability of cars, are considered.

Modes of transport may be

private modes, such as walking, bicycle, car, motorbike,

public modes, such as buses, trains, ferries, trains, airplanes, or

shared modes, such as taxis, shared bikes, shared car, rented car.

The method may determine which modes of transport are available and only choose the available modes. For example, walking may by excluded if the weather forecast is for rain.

Other factors on which the determination of the cost may be based on include:

duration of the trip, such as travel time,

a participant's overall budget that must not be exceeded,

travel expenses that are associated with a mode of transport, such as fares, tolls, parking, taxi, shared car cost (e.g. GoGet),

additional expenses: activities, goods the participant wants to purchase,

convenience: number of transfers, amount walking, number of tickets (consolidated vs. individual tickets), availability of parking,

environmental friendliness: carbon footprint,

environmental factors: weather (rain, temperature, UV, humidity), pollution levels, health benefits of walking/cycling (calories, cardio etc),

scenic values,

social factors: trust levels with fellow passengers when sharing private vehicles (can either be expressed explicitly or extracted from connected social network graphs),

special benefits: wifi-access, cell phone coverage, availability of food (e.g., on trains), crowdedness on public transport depending on time of day,

reliability: for public transport, taxis, as well as variation in typical travel time, existence of cycle ways in case of using a bicycle.

The above factors may be context-dependent (e.g., depend of time of day, type of meeting to attend) and may be weighted differently for different participants according to preferences that are either stated explicitly by the participants or learned over time from choices that the participants make. In one example, a participant consistently chooses schedule items with more scenic travel routes from the offered set of optimised schedule items. The computer 304 then changes the preferences of that participant to favour schedule items with scenic travel routes.

The system may visualize the results on a map and as a text directions. In one example, the system asks a participant to choose a preferred option. In another example, the system asks the participant whether to add the selected option to his calendar.

It will be appreciated by persons skilled in the art that numerous variations and/or modifications may be made to the specific embodiments without departing from the scope as defined in the claims. For instance, the schedule item of a calendar may be associated with a task that one or more participants need to complete. The parameters for the schedule item for the task may comprise location of the task, due date of the task and opening times of a shop if the task involves any purchasing.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “estimating” or “processing” or “computing” or “calculating”, “optimizing” or “determining” or “displaying” or “maximising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

1. A computer system for iteratively optimising a schedule item of a calendar the system comprising:
an input port to receive or a processor to determine one or more first candidate schedule items, each candidate schedule item having multiple parameters, and each parameter being fixed or variable, wherein each candidate schedule item comprises a value for each parameter;
a permutation module to determine one or more second candidate schedule items by permutating the variable parameters of each of the one or more first candidate schedule items;
a costing module to determine a cost for each of the one or more second candidate schedule items based on the values of the parameters;
a selection module to select a subset of the one or more second candidate schedule items based on the cost;
a feedback module to make available to the permutation module the subset of the one or more second candidate schedule items to be taken as the one or more first candidate schedule items; and
a data store to store the subset of the one or more second candidate schedule items.

2. The computer system of claim 1, wherein the schedule item and the candidate schedule items are associated with two or more participants.

3. The computer system of claim 1, wherein a second candidate schedule item determined by the permutation module from a first candidate schedule item differs from that first candidate schedule item in the value for one and only one variable parameter.

4. The computer system of claim 3, wherein determining the cost is based on a determined cost of similar candidate schedule items.

5. The computer system of claim 1, wherein the permutation module permutates one and only one variable parameter of each of the one or more first candidate schedule items, and wherein the permutation module creates one candidate schedule item for each possible value for the one and only one variable parameter.

6. The computer system of claim 5, wherein the computer system further comprises the feedback module to determine whether all variable parameters have been permutated and if so not send the subset of the one or more second candidate schedule items to the permutation module.

7. The computer system of claim 1, wherein
the one or more first candidate schedule items and the subset of the one or more second candidate schedule items each consist of one and only one candidate schedule item; and
permutating the variable parameters comprises creating exactly one candidate schedule item for each variable parameter, such that the created candidate schedule item and the first candidate schedule item differ in only that parameter.

8. The computer system of claim 7, wherein the system further comprises the permutation module to determine whether the cost of the selected candidate schedule item is lower than the cost of the candidate schedule item selected in the previous iteration and if not, to randomly change the value of one or more variable parameters of the selected candidate schedule item.

9. The computer system of claim 8, wherein the computer system further comprises the feedback module to determine whether a predetermined maximum number of random parameter changes is reached and if so not send the subset of the one or more second candidate schedule items to the permutation module.

10. The computer system of claim 1, wherein the calendar comprises a fixed schedule item and the cost for each of the one or more second candidate schedule items is based on the fixed schedule item.

11. The computer system of claim 1, wherein the parameters are one or more of:
starting time of the event;
location of the event;
mode of transport for each participant; and
return option for each participant.

12. The computer system of claim 11, wherein the starting time of the event is discrete, such that starting times with a predetermined time difference between each starting time are the possible values for the starting time of the event.

13. The computer system of claim 1, wherein the costing module determines a travel time for each participant and each candidate schedule item and wherein the cost is based on the travel time.

14. The computer system of claim 13, wherein the travel time is based on a routing for each participant.

15. The computer system of claim 14, wherein the routing is based on one or more of:
map based routing,
flight timetables, and
public transport timetables.

16. The computer system of claim 1, wherein the cost is based on any one or more of:
an expense associated with a value of a parameter;
convenience of the candidate schedule item;
carbon footprint associated with the candidate schedule item;
environmental factors of the candidate schedule item;
health benefits of the candidate schedule item;
social factors associated with the candidate schedule item;
robustness of the candidate schedule item; and
reliability associated with the candidate schedule item.

17. The computer system of claim 1, wherein the schedule item is associated with an event.

18. The computer system of claim 1, wherein the schedule item is associated with a task.

19. The computer system of claim 1, wherein the values for the multiple parameters of the one or more first candidate schedule items are predetermined default parameters.

20. The computer system of claim 1, wherein the system comprises a cache:
to receive a cost request from the costing module,
to query a data store for a similar request,
if a similar request is found to retrieve the cost associated with the request from the data store,
otherwise to determine the cost and store the cost associated with the received request on the datastore, and
to return the determined or retrieved cost to the costing module.

21. A computer implemented method for iteratively optimising a schedule item of a calendar, the method comprising the steps of:
receiving one or more first candidate schedule items, each candidate schedule item having multiple parameters, and each parameter being fixed or variable, wherein each candidate schedule item comprises a value for each parameter;
determining one or more second candidate schedule items by permutating the variable parameters of each of the one or more first candidate schedule items;
determining a cost for each of the one or more second candidate schedule items based on the values of the parameters;
selecting a subset of the one or more second candidate schedule items based on the cost;
determining whether a termination condition is met;
if the termination condition is not met repeating the method from the step of determining one or more second candidate schedule items where the subset of the one or more second candidate schedule items is taken as the one or more first candidate schedule items; and
if the termination condition is met storing on a data store the subset of the one or more second candidate schedule items.

22. A non-transitory computer readable medium with an executable program stored thereon that when executed causes a computer to perform the method of claim 21.
